(19) United States
(12) Patent Application Publication
(10) Pub. No.: US 2006/0217822 A1
(43) Pub. Date: Sep. 28, 2006

(54) Presenting status information of field devices in process control plants

(76) Inventors: Karthikeya Ramanathan, Bangalore (IN); Prasad Samudrala, Bangalore (IN)

Correspondence Address: HONEYWELL INTERNATIONAL INC., 101 COLUMBIA ROAD, P O BOX 2245, MORRISTOWN, NJ, 07962-2245, US

(21) Appl. No.: 11/145,734

(22) Filed: Jun. 6, 2005

(30) Foreign Application Priority Data
Mar. 28, 2005 (IN) 316/CHE/2005

(51) Int. Cl. G05B 15/00

(52) U.S. Cl. 700/83; 700/19

(57) ABSTRACT

A monitoring system provided according to an aspect of the present invention determines healthy an unhealthy field devices in a process control plant, and displays the healthy devices using one display attribute and unhealthy devices using another display attribute. According to another aspect, the unhealthy field devices are displayed as a group (e.g., list). Such features enable a user to quickly identify unhealthy devices and view detailed information corresponding to any unhealthy field device of interest quickly.

### RELATED APPLICATIONS

The present application is related to and claims priority from the co-pending India Patent Application entitled, “Presenting Status Information of Field Devices in Process Control Plants”, Serial Number: 316/CHE/2005, Filed: 28 Mar. 2005, naming the same inventors as in the subject patent application.

The present application is also related to the following co-pending US Applications, which are filed on even date herewith, and are incorporated in their entirety herewith:

1. Entitled, “Simplifying Integration of Field Devices Accessible by Different Network Protocols into a Field Device Management System”, Ser. No.: UNASSIGNED, Filed: UNASSIGNED, Attorney Docket Number: H0008304, Inventors: MARANAT et al;

2. Entitled, “Managing Field Devices Having Different Device Description Specifications in a Process Control System”, Ser. No.: UNASSIGNED, Filed: UNASSIGNED, Attorney Docket Number: H0008169, Inventors: BHANDIWAD et al and

3. Entitled, “Display of Historical Information Related to Field Devices Used in Process Control Plants”, Ser. No.: UNASSIGNED, Filed: UNASSIGNED, Attorney Docket Number: H0008312, Inventors: Surjya Narayana et al.

### BACKGROUND OF THE INVENTION

1. Field of the Invention

The present invention generally relates to process control systems, and more specifically to a method and apparatus for presenting status information of field devices in process control plants.

2. Related Art

A process control plant generally contains several field devices, which are operable to implement a desired control process (e.g., oil refinery, manufacturing operation, etc.). Examples of field devices include valves, positioners and switches, which are controlled to implement the control process.

Field devices may provide status related to the operation of the field device. For example, the status information could indicate temperature, pressure, extent of opening of a valve, light intensity, whether the device is malfunctioning (e.g., output saturated, input open), configuration values, calibration status, etc., of the field devices.

There has been a general recognized need to monitor the status of the field devices, at least during the operation of a plant. Typically, a monitoring system is provided to receive and display the status information. It is desirable that the status information be organized meeting one or more requirements to facilitate various operational goals such as quick problem identification, resolution, etc.

### SUMMARY

A monitoring system provided according to an aspect of the present invention displays healthy field devices (of a process control plant) with one display attribute, and unhealthy field devices with another display attribute. Due to such a display, an operator attention may be quickly drawn to unhealthy devices.

According to another aspect of the present invention, the monitoring system displays the unhealthy devices in a group (e.g., a linear list), again facilitating early detection of problems.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings, which are described below briefly.

FIG. 1 is a block diagram illustrating an example environment in which various aspect of the present invention can be implemented.

FIG. 2A is a flow chart illustrating the manner in which healthy and unhealthy field devices of a process control plant are displayed according to an aspect of the present invention.

FIG. 2B is a flowchart illustrating the manner in which unhealthy devices are displayed in a group according to another aspect of the present invention.

FIG. 3A contains a screen depicting various portions of a display screen in an embodiment of the present invention.

FIG. 3B contains a screen depicting the manner in which healthy and unhealthy devices are displayed with different display attributes in an embodiment of the present invention.

FIG. 3C contains a screen depicting the manner in which unhealthy devices are displayed in a list even if the corresponding tree portion is not expanded/displayed in another portion.

FIG. 3D contains a screen depicting the manner in which the detailed status information is displayed upon selection of an unhealthy field device.

FIG. 4 is a block diagram illustrating the details of an embodiment in which various aspects of the present invention are operative by execution of software instructions in an embodiment of the present invention.

### DETAILED DESCRIPTION

1. Overview

A monitoring system provided according to an aspect of the present invention displays healthy field devices with a first set of display attributes, and unhealthy field devices with different attributes. A field device is considered unhealthy if the operational status warrants operator attention, and healthy otherwise. Operator attention would be warranted if the device is not fully operational (including loss of connectivity to network, malfunction, etc.).

Due to the use of such different display attributes, a user/operator may quickly locate unhealthy devices requiring attention, thereby lending to quick identification of problems in a process control environment.

Another aspect of present invention displays unhealthy field devices as a group (e.g., list in the embodiments described below), and a user can select an unhealthy field device of interest from the list to retrieve detailed information for the device. Such a feature may also enable a user to quickly identify problems in process control environments.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

### 2. EXAMPLE ENVIRONMENT

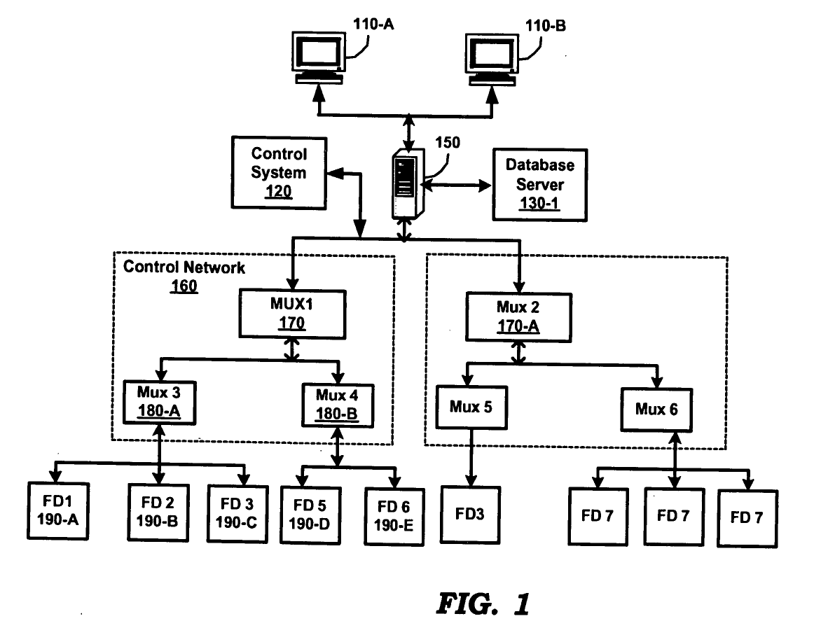

FIG. 1 is a block diagram illustrating the details of an example environment in which several aspects of the present invention can be implemented. The block diagram is shown containing field devices 190A through 190Z, control networks 160A and 160B, central server 150, database server 130, control system 120, and client systems 110A through 110Y. Each block is described below in detail.

Control network 160A is shown containing multiplexors 170A, 180A and 180B connecting central server 150 to field devices 190A through 190D, and control network 160B is shown containing multiplexers 170B, 180C and 180D connecting central server 150 to field devices 190E through 190H. As shown, multiplexors 180A and 180B are connected between multiplexer 170A and field devices 190A-190D, and multiplexors 180C and 180D are connected between multiplexer 170B and field devices 190E through 190H.

Each control network provides support for protocols such as FOUNDATION (™) Fieldbus, HART (™), PROFIBUS (™), MODBUS (™), Device-Net (™). or CAN protocols well known in the relevant arts. Each of the control networks 160A and 160B may be implemented using various network topology, and accordingly devices are connected in various physical groups. For example, multiplexers 180B, 180C and field device 190A are grouped together and connected to multiplexer 180A. Similarly field devices 190B, 190C and 190D are grouped and connected to multiplexer 180B.

Field devices 190A through 190Z perform various operations as specified by control system 120. The operations are designed to implement desired control processes. Database server 130 stores any information received from central server 150 and also generates replies to queries. Field devices, database server and control system can be implemented in a known way.

Multiplexer 180A multiplexes signals received from field devices 190A through 190C, and provides the multiplexed signals to multiplexer 170A. In addition, multiplexer 180A demultiplexes signals received from multiplexer 170A, and forwards the demultiplexed signal to the appropriate field device 190A-190D. The specific destination of the signals may be determined based on a destination address contained associated with each signal. Multiplexers 180C-180D and 170A-170B also operate similarly.

Central server 150 sends various status commands to field devices 190A through 190Z and receives corresponding status information through control network 160A and 160B. Additional information may be received by way of the protocol and configuration employed. The status messages indicate whether a field device is unhealthy (i.e., disconnected or not operating to desired capabilities) or healthy.

In one embodiment, the information corresponding to operation of each field device is obtained by examining a file (DD file) containing the device description (DD) for the corresponding field device type. Commands may be issued to the field devices to retrieve the desired information. Central server 150 may store various status information in database server 130.

Each client system 110A through 110X receives various status information from central server 150 and provides a user interface using which users may monitor (view information) field devices 190A through 190Z and corresponding multiplexers 180A through 180Y. The user interface provided according to an aspect of the present invention enables a user to quickly determine unhealthy devices, and also quickly access desired detailed information for unhealthy devices of interest, as described below in further detail.

3. Flow Charts

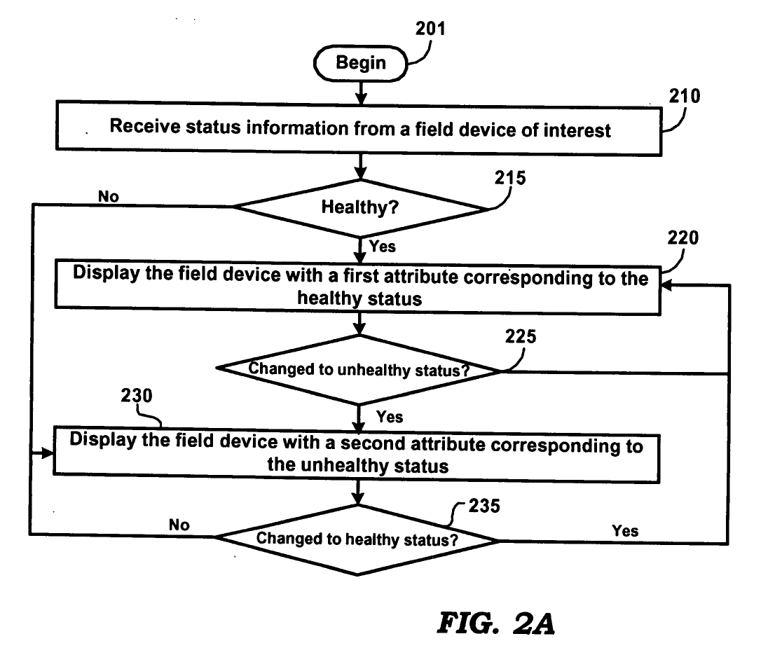

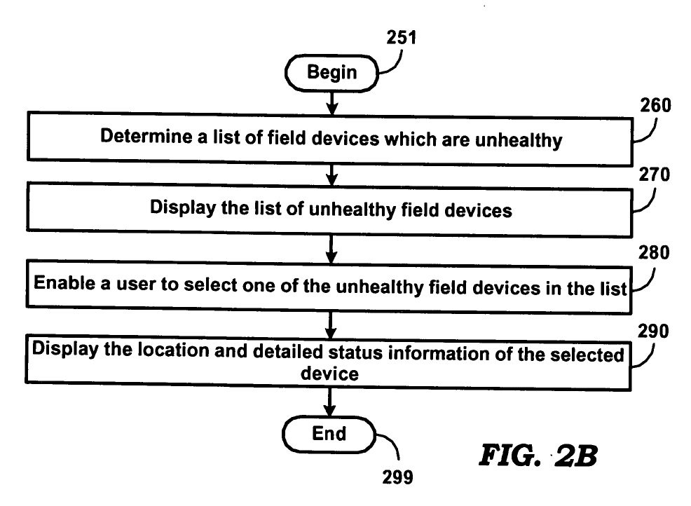

FIGS. 2A and 2B are flow charts, illustrating the manner in which user interface provided by a monitoring system according to various aspects of the present invention enables a user to quickly determine unhealthy devices, and also to quickly access desired detailed information for unhealthy devices of interest. The flowchart is described with respect to FIG. 1 merely for illustration. However, the approaches can , be implemented in other environments by other types of systems as well. Continuing with respect to FIG. 2A, the flowchart begins in step 201, in which control transfers to step 210.

In step 210, a monitoring system (in this case client system 110A) receives status information from a field device of interest. The status information corresponding to each field device can be received according to the description provide above (i.e., via central server 150). The received status information may contain data indicating present state of the device (such as whether the device is performing operations as desired or not, the temperature, pressure, etc., as applicable) along with various responses to the commands sent to the field device.

In step 215, the monitoring system determines whether the field device is healthy or unhealthy based on the received status information. The determination can be based on a single status message received from the field device or based on multiple status messages. Control passes to step 220 if the device is determined to be healthy, and to step 230 otherwise.

In step 220, the monitoring system displays the field device with a first attribute representing a healthy status. According to one convention, healthy field devices are displayed in green color. As a result, when a field device is determined to be healthy, the monitoring system provides a display of the corresponding device icon with green color.

In step 225, the monitoring system determines whether current status of a field device of interest has changed from a healthy status to unhealthy status. The determination can be based on responses to commands issued periodically (to the field device of interest), or from status messages received asynchronously from the field devices (when a corresponding state changes). Control passes to step 230 if the status is determined to have changed to unhealthy status, otherwise to step 220.

In step 230, the monitoring system displays the field device with a second attribute corresponding to the unhealthy status. According to the convention noted above, unhealthy devices are displayed with red color. Hence, when a field device is determined to be unhealthy, the monitoring system provides a display of the corresponding device icon with red color. However, alternative or complementary conventions, such as blinking or bold attributes may be used to display unhealthy field devices. Furthermore, the approaches can be enhanced to indicate different types of unhealthy status with different display attributes, without departing from the scope and spirit of various aspects of the present invention.

In step 235, the monitoring system determines whether the status of a field device of interest has changed from a unhealthy status to healthy status. If yes, control passes to step 220, otherwise to step 230. Due to the use of different attributes for displaying healthy and unhealthy devices as in FIG. 2A, a users attention may be quickly drawn to unhealthy devices (which are presently displayed on a display screen).

However, one potential problem with the approach of FIG. 2A is that several potentially large control networks may be monitored using a single monitoring system, and a display screen may not accommodate representation of all the field devices. The approach of FIG. 2B may overcome such a disadvantage, as described below.

Continuing with respect to the flowchart in FIG. 2B, the flowchart enables a user to easily identify all the unhealthy devices in potentially the entire control network, and quickly obtain detailed information corresponding to any of unhealthy devices in the network. The flowchart begins in step 251, in which control transfers to step 260.

In step 260, a monitoring system determines a list of field devices which are unhealthy. The list may be determined and updated periodically as described above with reference to FIG. 2A.

In step 270, the monitoring system displays the list of unhealthy field device. The list can be displayed using a combination of icons and text, according to conventions determined to be suitable in the specific environments.

In step 280, the monitoring system enables a user to select one of the unhealthy field devices from the displayed list. Various techniques (such as clicking using a mouse, or selecting using a key-board) can be used to enable the selection, depending on the specific input devices available in the monitoring system.

In step 290, the monitoring system displays the location and detailed status information of the selected device. The location indicates the position in the logical topology/hierarchy at which the selected field device is connected. The provided detailed information may assist the user in identifying corrective measures. The flowchart ends in step 299.

Thus, monitoring systems provided according to the approaches in FIGS. 2A and 2B enables a user to quickly determine unhealthy devices, and also to quickly access desired detailed information for unhealthy devices of interest. As a result, a user may quickly locate unhealthy devices requiring attention, thereby lending to quick identification of problems in a process control environment.

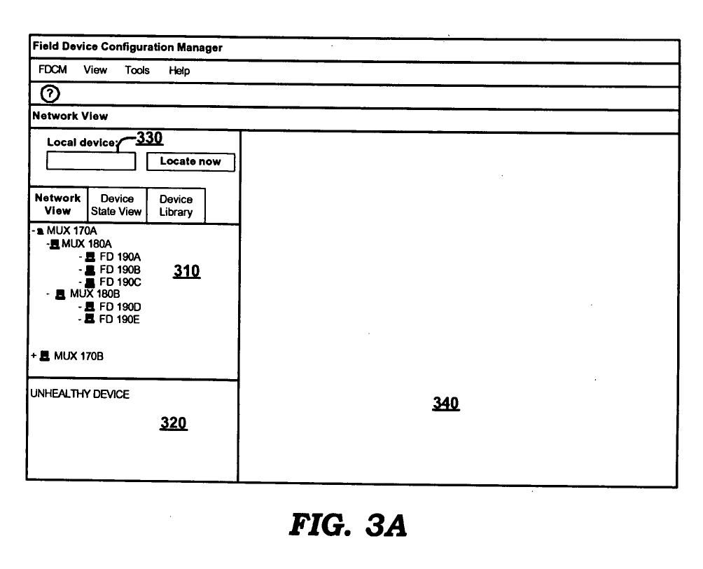

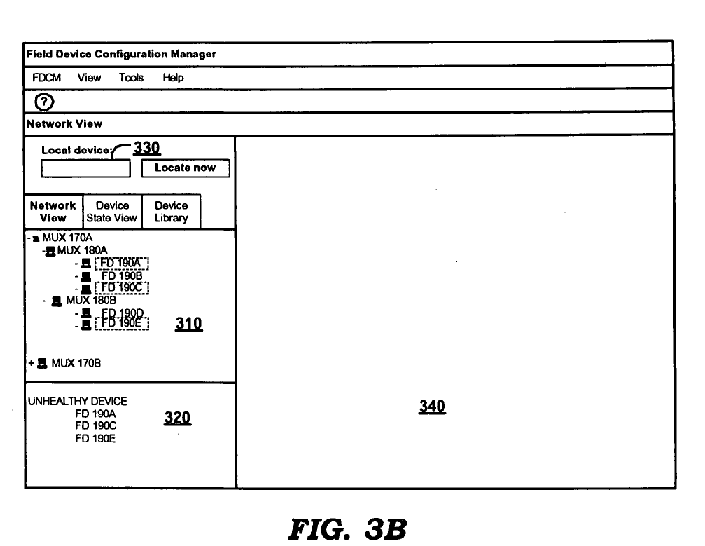

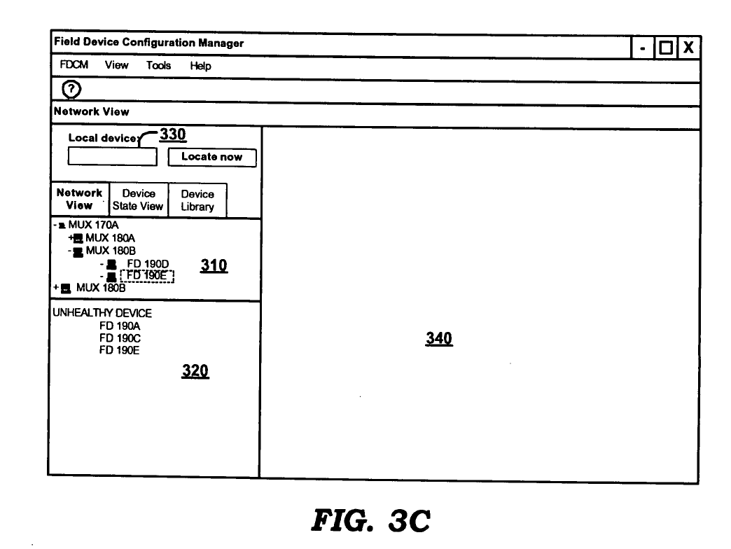

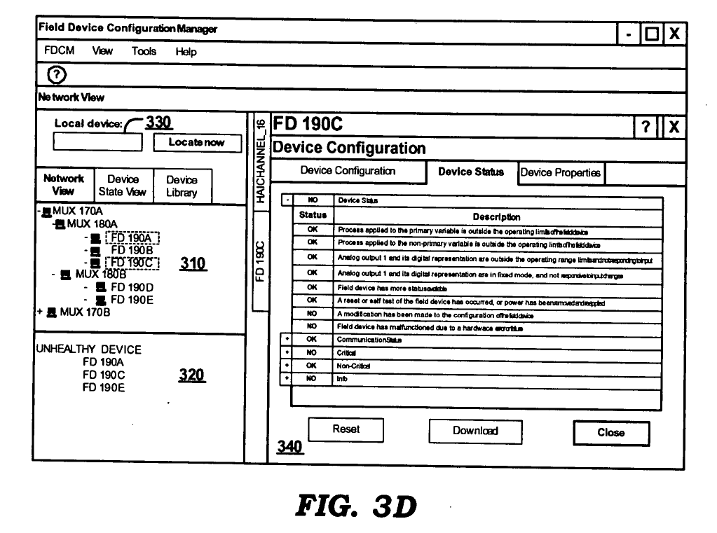

An example implementation of monitoring system providing display according to the approach described in FIGS. 2A and 2B is illustrated below with respect to FIGS. 3A-3D.

### 4. EXAMPLE

FIGS. 3A-3D are example display portions illustrating the manner in which the status information for various field device is displayed according to various aspects of present invention. As can be seen, the screen in each Figure contains four portions 310, 320, 330 and 340, and the display in portion 310 corresponds to the device hierarchy of FIG. 1. Each portion is described below in further detail.

FIG. 3A corresponds to display selected by a user. Portion 310 contains a navigable menu structure, with the topology of the field devices being present at the highest level. The user may select a field device of interest, and view corresponding detailed information in portion 340.

For illustration unhealthy devices are shown with an attribute of rectangular box around device ID and healthy devices are displayed without such rectangular shape around device ID. All the field devices are indicated as being healthy assuming the present status of all the devices is healthy. Accordingly, the list of unhealthy devices in portion 320 is empty.

FIG. 3B corresponds to a situation in which devices 190A, 190C and 190E are in unhealthy status, and the remaining devices are in healthy status. Accordingly, a rectangle box is displayed around each of devices 190A, 190C and 190E (represented by corresponding device identifiers). In addition, the list of unhealthy devices are displayed in portion 320, as shown. Due to such features, a user monitoring set of devices may quickly identify the unhealthy devices from the set of presently monitored devices.

FIG. 3C illustrates the display of field device in unhealthy list (portion 320) even though the corresponding field device is not displayed in portion 310. Thus, it can be seen that field devices 190A and 190C are listed as unhealthy devices in portion 320, even though the corresponding tree portion MUX 180A is shown in a collapsed state. Such a feature is particularly useful when monitoring a large number of field devices since the entire tree structure often does not fit on a single display screen.

FIG. 3D represents the manner in which detailed information (preferably the data indicating why the device was determined to be unhealthy) for an unhealthy device is displayed when a user selects the corresponding device. The user may select a field device of interest by entering the device ID (the displayed labels in one embodiment) in the area 330 or by clicking on the corresponding entry in portions 310 or 320.

As a result, the path of the device (190C) is displayed in portion 310 (facilitating easy identification of the logical/physical location of the device in the topology), and the detailed status information corresponding to the selected device is displayed in portion 340.

Providing user interfaces such as those displayed above, a monitoring system may provide a user the ability to quickly identify unhealthy devices, as well as view detailed status information for the devices of interest. The features described can be implemented in various digital processing systems, as described below with example.

5. Software Implementation

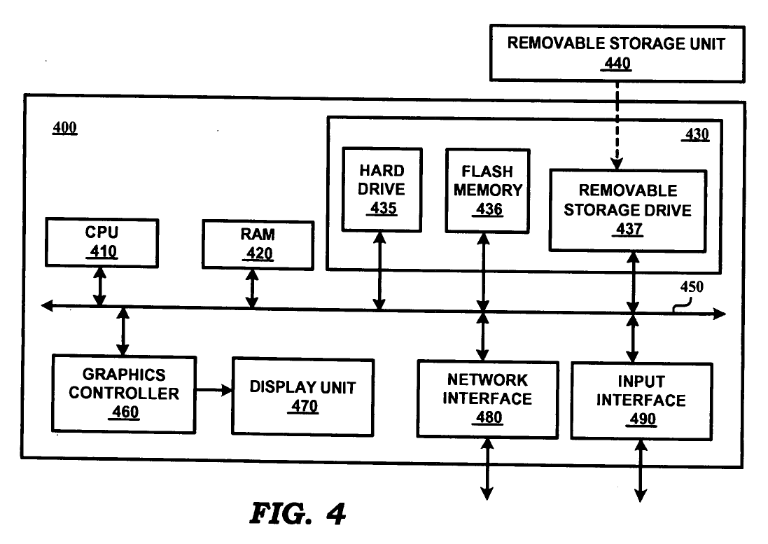

FIG. 4 is a block diagram illustrating the details of digital processing system 400 implemented substantially in the form of software in an embodiment of the present invention. System 400 may correspond to monitoring system (combination of central server 150 and client system 110A to 110X). System 400 may contain one or more processors such as central processing unit (CPU) 410, random access memory (RAM) 420, secondary memory 430, graphics controller 460, display unit 470, network interface 480, and input interface 490. All the components except display unit 470 may communicate with each other over communication path 450, which may contain several buses as is well known in the relevant arts. The components of FIG. 4 are described below in further detail.

CPU 410 may execute instructions stored in RAM 420 to provide several features of

the present invention. CPU 410 may contain multiple processing units, with each processing

unit potentially being designed for a specific task. Alternatively, CPU 410 may contain only

a single general purpose processing unit. RAM 420 may receive instructions from secondary memory 430 using communication path 450.

Graphics controller 460 generates display signals (e.g., in RGB format) to display unit

470 based on data/instructions received from CPU 410. Display unit 470 contains a display

screen to display the images defined by the display signals. The screens of FIGS. 3A-3D can be displayed on display unit 470 (of client system 110A). Input interface 490 may correspond to a key-board and/or mouse. The input/output devices enable a suitable user interface, using which users may monitor field devices, as described above.

Network interface 480 provides the physical, electrical and protocol interfaces needed for each system. In the case of client systems 180A-180Y, a network connection to communicate on a local area network (to which central server 150 is also connected) using protocols such as TCP/IP may be sufficient. On the other hand, in case of central server 150, in addition to such a network connection, a control network connection to interface with control networks 160A and 160B may be necessary.

Secondary memory 430 may contain hard drive 435, flash memory 436 and removable storage drive 437. Secondary memory 430 may store the data and software instructions, which enable system 400 to provide several features in accordance with the present invention. Some or all of the data and instructions may be provided on removable storage unit 440, and the data and instructions may be read and provided by removable storage drive 437 to CPU 410. Floppy drive, magnetic tape drive, CD-ROM drive, DVD Drive, Flash memory, removable memory chip (PCMCIA Card, EPROM) are examples of such removable storage drive 437.

Removable storage unit 440 may be implemented using medium and storage format

compatible with removable storage drive 437 such that removable storage drive 437 can read

the data and instructions. Thus, removable storage unit 440 includes a computer readable storage medium having stored therein computer software and/or data.

In this document, the term “computer program product” is used to generally refer to removable storage unit 440 or hard disk installed in hard drive 435. These computer program products are means for providing software to system 400. CPU 410 may retrieve the software instructions, and execute the instructions to provide various features of the present invention described above.

### 6. CONCLUSION

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of enabling a user to monitor a plurality of field devices contained in a process control plant, said method comprising:
determining a first set of field devices which are healthy and a second set of field devices which are unhealthy, wherein each of said first set of field devices and said second set of field devices are contained in said plurality of field devices; and
displaying said first set of field devices with a first display attribute and said second set of field devices with a second display attribute, wherein said first display attribute is different from said second display attribute.

2. The method of claim 1, wherein each of said first set of field devices is fully operational as desired, and each of said second set of field devices is less than fully operational.

3. The method of claim 2, wherein said first attribute comprises green color and said second attribute comprises red color.

4. A method of enabling a user to monitor a plurality of field devices contained in a process control plant, said method comprising:
determining a first set of field devices which are unhealthy, wherein said first set of field devices are contained in said plurality of field devices;
displaying said set of field devices in a group, such that all of said first set of field devices can be quickly identified together.

5. The method of claim 4, wherein said group comprises a list displayed in successive lines.

6. The method of claim 4, further comprising enabling said user to select one of said first of field devices, and displaying information representing the health of the selected device.

7. A computer readable medium carrying one or more sequences of instructions for causing a system to enable a user to monitor a plurality of field devices contained in a process control plant, wherein execution of said one or more sequences of instructions by one or more processors contained in said system causes said one or more processors to perform the actions of:
determining a first set of field devices which are healthy and a second set of field devices which are unhealthy, wherein each of said first set of field devices and said second set of field devices are contained in said plurality of field devices; and
displaying said first set of field devices with a first display attribute and said second set of field devices with a second display attribute, wherein said first display attribute is different from said second display attribute.

8. The computer readable medium of claim 7, wherein each of said first set of field devices is fully operational as desired, and each of said second set of field devices is less than fully operational.

9. The computer readable medium of claim 8, wherein said first attribute comprises green color and said second attribute comprises red color.

10. A computer readable medium carrying one or more sequences of instructions for causing a system to enable a user to monitor a plurality of field devices contained in a process control plant, wherein execution of said one or more sequences of instructions by one or more processors contained in said system causes said one or more processors to perform the actions of:
determining a first set of field devices which are unhealthy, wherein said first set of field devices are contained in said plurality of field devices;
displaying said set of field devices in a group, such that all of said first set of field devices can be quickly identified together.

11. The computer readable medium of claim 10, wherein said group comprises a list displayed in successive lines.

12. The computer readable medium of claim 10, further comprising enabling said user to select one of said first of field devices, and displaying information representing the health of the selected device.
